(19) United States
(12) Patent Application Publication
(10) Pub. No.: US 2002/0078341 A1
(43) Pub. Date: Jun. 20, 2002

(54) System and method for applying quality of service policies to internet protocol security to avoid bandwidth limitations on a computer network

(76) Inventors: Denise M. Genty, Austin, TX (US); Shawn P. Mullen, Buda, TX (US); Guha P. Venkataraman, Austin, TX (US)

Correspondence Address: Edmond A. DeFrank, 20145 Via Medici, Northridge, CA, 91326, US

(21) Appl. No.: 09/737,042

(22) Filed: Dec. 14, 2000

(51) Int. Cl. H04L 9/00

(52) U.S. Cl. 713/151; 713/153

(57) ABSTRACT

A system and a method for managing network packets by applying quality of service (QoS) policies to internet protocol security (IPsec) on a virtual private computer (VPN) to avoid bandwidth limitations. The present invention allows the same QoS policy model (that gives preferential treatment to high-priority network packets) to be used by QoS programs to direct the flow of network packets over the network and to be used by IPsec programs for the cryptographic processing (encryption/decryption) of network packets. The present invention allows high-priority packets to receive preferential treatment when travelling over the network and when being encrypted and decrypted. In general, the system of the present invention includes a system for applying QoS policies to IPsec programs, and includes an IPsec module that encrypts and decrypts network packets, a QoS module that directs the flow of network packets over the network, and a QoS policy module that provides a policy model containing rules and criteria dictating the order in which packets should be processed. The method of the present invention uses the above system and includes method of managing network packets on a computer network by applying QoS policy to IPsec programs.

### BACKGROUND OF THE INVENTION

1. Field of the Invention

The present invention relates in general to computer networks and more particularly to a system and a method for applying quality of service policies to internet protocol security on a virtual private network (VPN) to avoid bandwidth limitations on a computer network.

2. Related Art

Computer networks are widespread and vitally important in many diverse applications including business, universities and government. In general, a computer network is two or more computers (or associated devices) that are connected by communication facilities. A computer network generally includes a server, which is a computer that provides shared resources to users of the network, and a client, which is a computer that accesses the shared network resources provided by the server using the communication facilities. For example, the Internet (via the World Wide Web (WWW)) is a public wide-area network (WAN) environment that enables remote clients to request and receive data located on a server.

Businesses and other entities often have the need to establish a private WAN in order to link offices that are distributed over a wide geographical area. These businesses are faced with a variety of ways in which the private WAN may be constructed, with the general rule being that paying more provides better service. For example, the Internet is an inexpensive and global way to enable WAN communications, but cannot provide the security, bandwidth or quality of service (QoS) guarantees that usually are associated with the substantially more expensive private networks (such as a leased line, Frame Relay, or an asynchronous transfer mode (ATM) network). Thus, if a business tries to build its WAN using the Internet it generally will pay much less than private networks but get an inferior service.

The Internet, however, is currently undergoing a transition from a service model where all transmissions are equal and no delivery guarantees are made to one in which predictable and different levels of service can be guaranteed. One type of technology currently being considered to enable this transition is called an “extranet” or virtual private network (VPN). The VPN provides the best of both worlds by providing the security, performance, availability and multiprotocol support of private networks over the inexpensive and pervasive Internet. The VPN uses encryption and other security mechanisms to ensure that only authorized users can access the private WAN and that the data cannot be intercepted by unauthorized users. Thus, VPN enables a private WAN to be built using the Internet as the medium for transporting data.

In order to facilitate different levels of service, provide suitable bandwidth and security when using the Internet, VPN technology uses QoS and Internet protocol security (IPsec). In general, the transmission of information over a network is provided by QoS and the security (such as cryptography) is provided by IPsec. IPsec is a set of protocols that supports a secure exchange of packets (or unit of transmitted data) over the Internet. This secure exchange is facilitated by using IP tunneling to encrypt a packet on the transmitting computer and then decrypt the packet at the receiving computer. The QoS technology allows a consistent and predictable amount of data to be delivered over a network. QoS ensures that a customer receives a guaranteed network throughput or bandwidth (the amount of data that can be transferred in a fixed amount of time) such that the network is transparent to network users. QoS technology addresses the problem of limited bandwidth when network traffic is sharing the bandwidth on a fairly equal basis (such as on the Internet) by allowing for the network to be configured such that certain traffic is given preferential or expedited network or routing service.

QoS addresses the problem of limited bandwidth on the Internet by using a set of priority policies. These priority policies (or QoS policies) assign each network packet a certain priority level (such that all network packets are not treated equally) and allow certain network packets to be given preferred treatment over other network packets. In general, these policies are regulations and rules that instruct QoS how to administer network resources based on a given criteria. In other words, QoS policies are a basis that QoS uses to discriminate against or extend preferential treatment to certain network packets.

One problem, however, is that IPsec does not have any priority policies similar to QoS. This means that when a VPN is established using the Internet, QoS technology ensures that the limiting bandwidth that impedes the maximum throughput of the network is not the network bandwidth but instead the IPsec portion of the VPN. Thus, by way of example, if a high-priority packet is transmitted over a VPN after a low-priority packet, QoS will give the high-priority packet preferential treatment. However, once the high-priority packet reaches the receiving computer and is decrypted, the decryption processes treats the high-priority packet the same as the low-priority packet. In other words, if the low-priority packet is received by the decryption program slightly before the high-priority packet, the high-priority packet has to wait for the low-priority packet to be decrypted. This greatly slows down a high-priority packet at the encryption/decryption level. Even though QoS gives the high-priority preferential treatment during transmission on the network, when the high-priority packet arrives at a destination computer the high-priority packet still must wait to be decrypted, even if a packet having a much lower priority is ahead. Thus, although the high-priority packet is given preferential treatment on the network during encryption/decryption the high-priority packet is merely given identical treatment as other packets, with each packet being encrypted/decrypted in a first come/first serve order. This adversely affects the speed at which high-priority packets are sent and received over a network.

Therefore what is needed is a way to eliminate and avoid the bandwidth limitations on a VPN cause by the lack of preferential treatment for high-priority packets during the encryption/decryption process. What is further needed is a system and method that provides priority policies (such as QoS policies) for IPsec during the encryption and decryption process that enables a high-priority packet to be given preferential treatment over a low-priority packet during the encryption/decryption process.

### SUMMARY OF THE INVENTION

To overcome the limitations in the prior art as described above and other limitations that will become apparent upon reading and understanding the present specification, the present invention includes system and a method for applying quality of service (QoS) policies to internet protocol security (Ipsec) on a virtual private network (VPN). By using transferring and applying the same set of policies to both network addressing and cryptographic (encryption/decryption) processing of network packets, preferential treatment of high-priority network packets are provided both during network transmission and during encryption/decryption. In particular, the present invention transfer the QoS policy model to the IPsec security program and the IPsec security program applies the QoS policies to the encryption/decryption of network packets such that encryption/decryption can be suspended in favor of a network packet having a higher priority. Thus, the present invention allows the QoS and IPsec programs to use the same set of priority policies to give identical preferential treatment to high-priority network packets and overcome bandwidth limitations on the network.

In general, the system of the present invention includes a system that applies QoS policies to IPsec programs, and includes an IPsec module that encrypts and decrypts network packets, a QoS module that provides certain network traffic preferential or expedited network or routing service, and a QoS policy module that contains the QoS policies that inform QoS the regulations and criteria for discriminating against or extending preferential treatment to network packets. The IPsec module includes an encryption module that encrypts network packets, a decryption module that decrypts network packets and a module containing other IPsec programs. The QoS policy module is in communication with both the QoS module and the IPsec module such that the QoS policy model is transferred to the IPsec module. The IPsec module applies the QoS policies to the cryptographic (encryption/decryption) processing of network packets and the QoS module applies the same QoS policies to the transmission and reception of network packets.

The method of the present invention uses the above system and includes method of managing network packets on a computer network by applying QoS policy to IPsec programs. More specifically, the method of the present invention transmits and receives network packets over the network using QoS and QoS policies, transfers the QoS policies containing a set of regulations and criteria that determine which network packets should be given priority to the cryptographic processing, and perform cryptographic processing of the network packets in accordance with the QoS policies. The QoS policy model is applied to the cryptographic processing during both the IPsec encryption and decryption of network packets. By applying the QoS policy model to both QoS programs and IPsec programs, the flow of high-priority network packets can be optimized such that bandwidth limitations can be avoided.

Other aspects and advantages of the present invention as well as a more complete understanding thereof will become apparent from the following detailed description, taken in conjunction with the accompanying drawings, illustrating by way of example the principles of the invention. Moreover, it is intended that the scope of the invention be limited by the claims and not by the preceding summary or the following detailed description.

### BRIEF DESCRIPTION OF THE DRAWINGS

The present invention can be further understood by reference to the following description and attached drawings that illustrate the preferred embodiments. Other features and advantages will be apparent from the following detailed description of the invention, taken in conjunction with the accompanying drawings, which illustrate, by way of example, the principles of the present invention.

Referring now to the drawings in which like reference numbers represent corresponding parts throughout:

FIG. 1 illustrates a conventional hardware configuration for use with the present invention.

FIG. 2 is a block diagram of an individual computer system of FIG. 1 incorporating the present invention and is shown for illustrative purposes only.

FIG. 3 is a block diagram illustrating the components of the present invention.

FIG. 4 is a flow diagram illustrating the general operation of the present invention.

### DETAILED DESCRIPTION OF THE INVENTION

In the following description of the invention, reference is made to the accompanying drawings, which form a part thereof, and in which is shown by way of illustration a specific example whereby the invention may be practiced. It is to be understood that other embodiments may be utilized and structural changes may be made without departing from the scope of the present invention.

I. Introduction

Current network packet management techniques for virtual private networks (VPN) use quality of service (QoS) programs to address outgoing network packets and internet protocol security (Ipsec) to provide cryptographic processing (encryption and decryption) of network packets. The QoS programs use QoS policies that provide for preferential handling of high-priority network packets, while IPsec programs do not use these policies. One problem with this management technique, however, is that even though QoS give preferential treatment to high-priority network packets during transmission and reception of the packets on the network, during encryption and decryption of network packets under IPsec these same high priority packets not given preferential treatment and all packets are treated as equal.

The present invention allows the same QoS policy model that QoS programs use to give preferential treatment to high-priority packets during transmission and reception on the network to control the cryptographic processing of the network packets under IPsec programs. In effect, this permits the present invention to give high-priority network packets the same preferential treatment during transmission/reception on the network and during cryptographic processing. Thus, the present invention transfers and applies the QoS policy model both to QoS programs and IPsec programs performing encryption and decryption of network packets, and the IPsec programs provide the same preferential treatment to high-priority packets. For example, if the QoS programs that are following the QoS policy model determine that a high-priority network packet should be given preferential treatment during transmission or reception over the network, then IPsec will also provide this preferential treatment to the high-priority packet during encryption/decryption. This means that IPsec will suspend the encryption or decryption of a low-priority packet in favor of a high-priority packet. This unified management technique of network packets ensures that bandwidth limitations on the computer network are avoided and that high-priority packets are quickly and efficiently transmitted through the network.

II. Exemplary Operating Environment

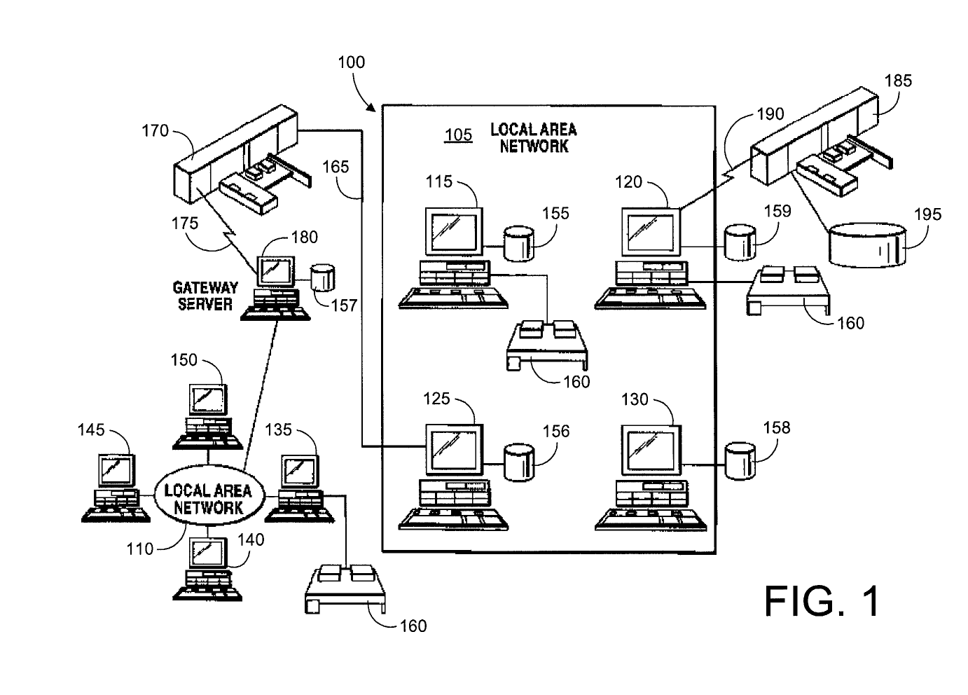

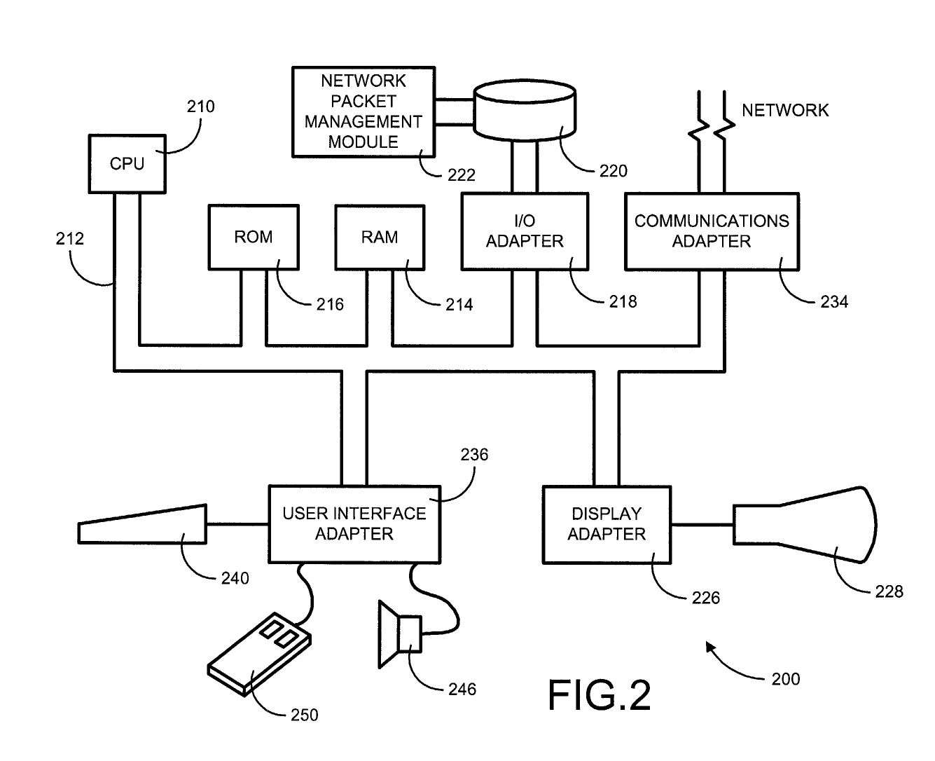

The following discussion is designed to provide a brief, general description of a suitable environment in which the present invention may be implemented. It should be noted that FIGS. 1 and 2 depict only one of several ways in which the present invention may be implemented.

FIG. 1 illustrates a conventional hardware configuration for use with the present invention. In particular, a computer system 100 may include one or more networks, such as local area networks (LANs) 105 and 110. Each of the LANs 105,110 includes a plurality of individual computers 115,120,125,130,135, 140,145 and 150. The computers within the LANs 105,110 may be any suitable computer such as, for example, a personal computer made by International Business Machines (IBM) Corporation, located in Armonk, N.Y. Typically, each of the plurality of individual computers is coupled to storage devices 155, 156, 157,158 and 159 (such as a disk drive or hard disk) that may be used to store data (such as modules of the present invention) and computer-executable instructions in accordance with the present invention. Each of the plurality of individual computers 115,120,125,130,135, 140, 145,150 also may be coupled to an output device 160 (such as a printer) for producing tangible output. The LANs 105, 110 may be coupled via a first communication link 165 to a communication controller 170, and from the communication controller 170 through a second communication link 175 to a gateway server 180. The gateway server 180 is preferably a personal computer that serves to link the LAN 105 to the LAN 110.

The computer system 100 may also include a plurality of mainframe computers, such as a mainframe computer 185, which may be in communication with one or more of the LANs 105, 110 by means of a third communication link 190. The mainframe computer 185 is typically coupled to a storage device 195 that is capable of serving as a remote storage for one or more of the LANs 105,110. Similar to the LANs 105,110 discussed above, the storage device may be used to store data and computer-executable instructions in accordance with the present invention. Those skilled in the art will appreciate that the mainframe computer 185, the LAN 105 and the LAN 110 may be physically located a great distance from each other. By way of example, a user may use a client of the mainframe computer 185 to access information located on a server of the LAN 105. The client of the mainframe computer 185 and the server of the LAN 105 would exchange information by sending transmitting and receiving network packets. As explained in detail below, using the present invention these network packets would be managed optimized such that bandwidth limitations on the network are avoided.

FIG. 2 is a block diagram of an individual computer system of FIG. 1 incorporating the present invention and is shown for illustrative purposes only. A computer 200 includes any suitable central processing unit (CPU) 210, such as a standard microprocessor, and any number of other objects interconnected by a system bus 212. For purposes of illustration, the computer 200 includes memory such as random-access memory (RAM) 214, read-only memory (ROM) 216, and storage devices (such as hard disk or disk drives 220) connected to the system bus 212 by an inpuvoutput (I/O) adapter 218. The computer 200 may be a client computer that is capable of connecting and interacting with a server using network packets. Accordingly, as shown in FIG. 2, the storage device 220 contains a network packet management module 222 accordance with the present invention that contains computer-executable instructions for carrying out the present invention.

The computer 200 further includes a display adapter 226 for connecting the system bus 212 to a suitable display device 228. In addition, a user interface adapter 236 is capable of connecting the system bus 212 to other user interface devices, such as a keyboard 240, a speaker 246, a mouse 250 and a touchpad (not shown). In a preferred embodiment, a graphical user interface (GUI) and an operating system (OS) reside within a computer-readable media and contain device drivers that allow one or more users to manipulate object icons and text on the display device 228. Any suitable computer-readable media may retain the GUI and OS, such as, for example, the RAM 214, ROM 216, hard disk or disk drives 220 (such as magnetic diskette, magnetic tape, CD-ROM, optical disk or other suitable storage media).

III. General Component Overview

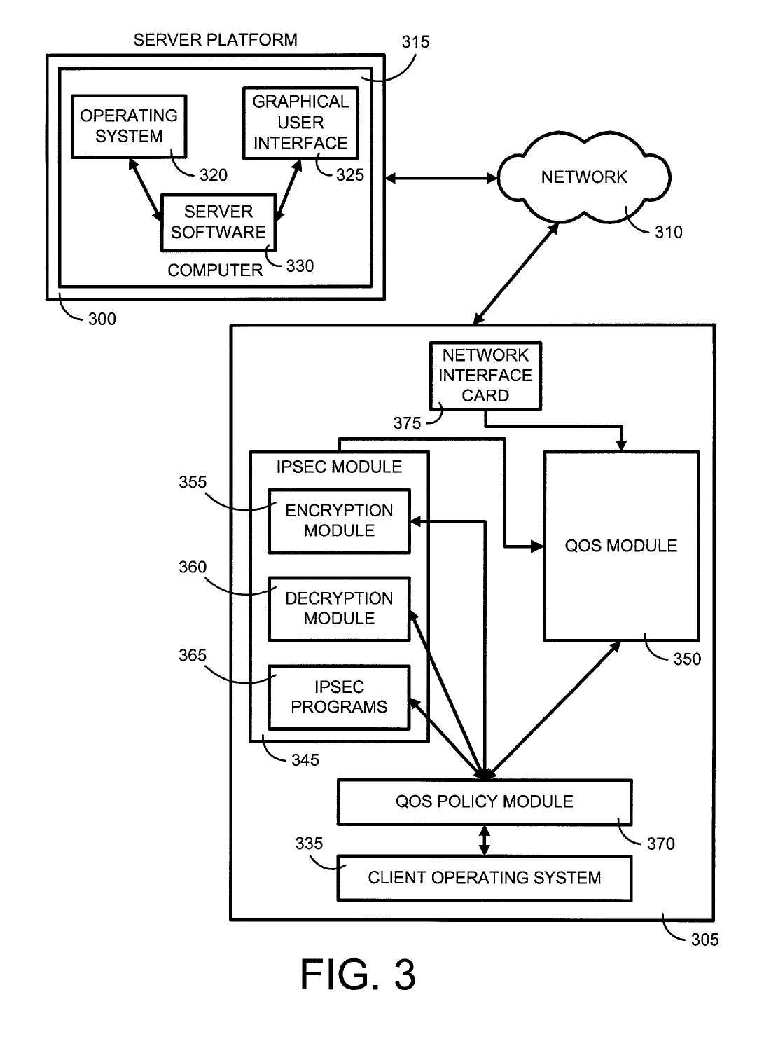

FIG. 3 is a block diagram illustrating the components of the present invention. In this preferred embodiment, a server platform 300 communicates with a client 305 through a network 310 (such as the Internet). The server platform includes a server computer 315 and an operating system 320 on the server computer 315 that distributes system resources. The server computer 315 also includes a graphical user interface (GUI) 325, for displaying information to a user, and server software 330 that operates the server computer 315.

The client 305 includes a client operating system 335 that manages system resources on the client 305. In addition, the client 305 includes an IPsec module 345 and a QoS module 350. The IPsec module 345 provides network security (such as cryptographic processing or encryption/decryption processing) and includes an encryption module 355, for encrypting outgoing network packets, a decryption module 360, for decrypting incoming network packets, and other IPsec programs 365. The QoS module 350 provides addressing of outgoing network packets.

A QoS policy module 370 is in communication with both the QoS module 350 and the IPsec Module 345 and transfers a QoS policy model to both modules. This enables QoS policies to be applied to the QoS module 350, the encryption module 355, the decryption module 360 and other IPsec programs 365. The QoS policy module 370 contains regulations and criteria concerning priorities and preferential treatment of network packets that enable the IPsec module 345 and the QoS module 350 to use QoS policies to efficiently manage the flow of incoming and outgoing network packets in unison with the encryption and decryption of these packets. In other words, the QoS policy model provides rules that govern the order in which processing (either by the QoS module 350 or the IPsec module 345) should be performed. The network interface card 375 receives and transmits the network packets over the network 310. In general, an outgoing network packet will first be sent to the IPsec module 345 for cryptographic processing (such as encryption) and then to the QoS module 350 for addressing and sequencing prior to being sent to the network interface card 375 and out over the network 310. Similarly, an incoming network packet will be received by the network interface card 375, sent to the QoS module 350 and then to the IPsec module 345 for cryptographic processing (such as decryption). For both incoming and outgoing network packets the present invention provides priority policies from the QoS policy module 370 to both the IPsec module 345 and the QoS module 350 for processing of the network packets.

IV. Operation of the Invention

In general, the system and method of the present invention applies a QoS policy model (containing priority policies) to both QoS programs directing the flow of network packets over the network and IPsec programs directing the secure cryptographic processing (such as encryption and decryption) of network packets. Network bandwidth limitations are mitigated by having a uniform set of priority policies applied to management of the network packets.

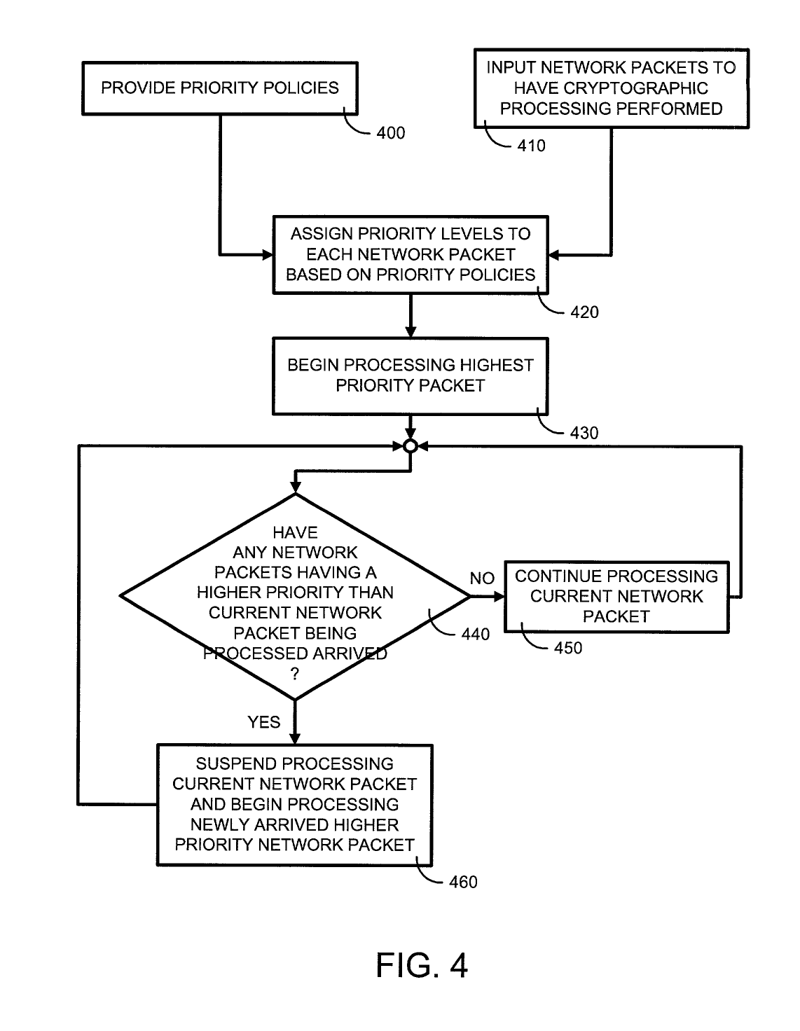

FIG. 4 is a flow diagram illustrating the general operation of the present invention. The operation of the present invention includes providing priority polices (box 400). Preferably, these priority polices are QoS policies and are the same polices used by the QoS programs. By way of example, these priority polices may be a set of priority tables dictating the order in which order network packets are processed. Network packets are received as input to have cryptographic processing performed (box 410). This cryptographic processing includes encryption (such as of outgoing packets) and decryption (such as of incoming packets). Each network packets is assigned a priority level based on the priority policies provided (box 420).

The network packet having the highest priority is selected and cryptographic processing is begun on this network packet (box 430). Meanwhile, the present invention checks to determine whether any network packets having a higher priority than the current network packet being processed have arrived for processing (box 440). If not, then the present invention continues processing of the current network packet (box 450). Otherwise, processing of the current network packets is suspended in favor of the higher priority network packet that was recently received (box 460). Thus, current processing of any lower-priority network packet whenever a higher-priority network packet is received for cryptographic processing. In this way the present invention ensures that high-priority network packets are not significantly slowed down during the encryption/decryption processing.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description of the invention, but rather by the claims appended hereto.

What is claimed is:

1. A method for processing network packets on a computer network, comprising:
transferring the network packets over the computer network based on a policy wherein network packets having a high priority are transferred before network packets having a low priority; and
performing cryptographic processing of the network packets using the policy.

2. The method of claim 1, wherein cryptographic processing includes encryption and decryption of network packets.

3. The method of claim 1, wherein cryptographic processing is performed such that processing of the network packets having a low priority are suspended in favor of the network packets having the high priority.

4. The method of claim 1, wherein the policy is a quality of service policy model.

5. The method of claim 1, wherein performing cryptographic processing further comprises processing the network packets having the highest priority and continually checking whether a higher-priority network packet than a network packet being processed is available for processing.

6. The method of claim 5, further comprising determining that a higher-priority packet than the network packet being processed is available to have cryptographic processing performed and suspending processing of the network packet being processed and processing instead the higher-priority network packet.

7. A method for processing network packets on a computer network, comprising:
transferring the network packets over the network using quality of service programs that are based on quality of service policies;
performing cryptographic processing on the network packets using the quality of service policies;
wherein network packets having a high priority are transferred and cryptographically processed before network packets having a low priority.

8. The method of claim 7, wherein the quality of service policies are rules and criteria regarding a priority of the network packets.

9. The method of claim 7, wherein cryptographic processing includes periodically determining whether a higher-priority network packet than a current network packet being processed requires cryptographic processing.

10. The method of claim 9, wherein cryptographic processing includes stopping the current network packet being processed and processing the higher-priority network packet.

11. The method of claim 7, wherein cryptographic processing is performed using Internet protocol security programs for encrypting and decrypting the network packets.

12. A network packet management system for managing network packets on a computer network, comprising:
a quality of service policy module that contains priority polices for handling of the network packets;
a quality of service module in communication with the quality of service policy module that manages the sequencing of the network packets over the computer network based on the priority policies; and
a internet protocol security module in communication with the quality of service policy module that manages the encryption and decryption of the network packets based on the priority polices.

13. The network packet management system of claim 12, wherein the internet protocol security module comprises an encryption module for encrypting network packets and a decryption module for decrypting network packets.

14. The network packet management system of claim 12, wherein the priority policies are based on a quality of service policy model.

15. The network packet management system of claim 12, wherein the priority polices are regulations that govern the order in which network packets are processed by the quality of service module and the internet protocol security module.

16. The network packet management system of claim 15, wherein the encryption module encrypts the network packets in order of priority with the highest-priority network packet being processed first.

17. The network packet management system of claim 16, wherein the encryption module receives a higher-priority network packet during the encryption of the highest-priority network packet and suspends encryption of the highest-priority network packet and encrypts the received higher-priority network packet.

18. The network packet management system of claim 15, wherein the decryption module decrypts the network packets in order of priority with the highest-priority network packet being processed first.

19. The network packet management system of claim 18, wherein the decryption module receives a higher-priority network packet during the decryption of the highest-priority network packet and suspends decryption of the highest-priority network packet and decrypts the received higher-priority network packet.
